(19) United States
(12) Patent Application Publication
(10) Pub. No.: US 2024/0104910 A1
(43) Pub. Date: Mar. 28, 2024

(54) METHOD AND APPARATUS OF OBTAINING POSITION OF STATIONARY TARGET

(71) Applicant: 42DOT INC., Seoul (KR)

(72) Inventors: Dong Kyu Park, Sejong (KR); Ji Won Seo, Seoul (KR); Yong Uk Lee, Seongnam (KR)

(21) Appl. No.: 18/454,085

(22) Filed: Aug. 23, 2023

(30) Foreign Application Priority Data
Aug. 26, 2022 (KR) 10-2022-0107629
Sep. 26, 2022 (KR) 10-2022-0121751

(51) Int. Cl. G06V 10/80; B60W 60/00; G06T 7/73; G06T 11/20; G06V 20/58

(52) U.S. Cl. CPC G06V 10/803; B60W 60/001; G06T 7/73; G06T 11/206; G06V 10/806; G06V 20/58; B60W 2420/408; B60W 2554/20; G06T 2207/30261

(57) ABSTRACT

Provided are a method and device for obtaining a position of a stationary target. The method of obtaining a position of a stationary target may include generating a fusion track based on data collected from a radar and data collected from a camera, determining whether the fusion track is in a stationary state, in response to the fusion track being in the stationary state, collecting radar points associated with the fusion track, and obtaining a center point of the stationary target based on the collected radar points.

### CROSS-REFERENCE TO RELATED APPLICATION

This application is based on and claims priority under 35 U.S.C. § 119 to Korean Patent Application No. 10-2022-0107629, filed on Aug. 26, 2022, in the Korean Intellectual Property Office and Korean Patent Application No. 10-2022-0121751, filed on Sep. 26, 2022, in the Korean Intellectual Property Office, the disclosure of which is incorporated by reference herein in its entirety.

### BACKGROUND

### 1. Field

The present disclosure relates to a method and device for obtaining a position of a stationary target.

### 2. Description of the Related Art

Radar (radio detection and ranging) enables detection of the position and direction of an object and measurement of the distance from and the speed of the object. Radars are widely used to detect a surrounding environment by using radio waves, but automotive radars are able to perform only a small number of detections due to low angle recognition performance, and thus, there may be limitations in identifying types of objects by using only the automotive radars.

In addition, with the recent development of deep learning technology, autonomous driving technology for recognizing a surrounding environment through a plurality of cameras equipped in a vehicle and generating a driving path of the vehicle based on the recognition has rapidly emerged. However, there may still be many challenges related to autonomous driving because various situations may occur in a road traffic environment and it is necessary to recognize surrounding environments in real time to make a decision. Meanwhile, sensor fusion technology for recognizing surrounding environments by combining a plurality of sensors has also attracted attention.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### SUMMARY

Provided are methods and devices for obtaining a position of a stationary target. Technical objectives of the present disclosure are not limited to the foregoing, and other unmentioned objects or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

Additional aspects will be set forth in part in the description which follows and, in part, will be apparent from the description, or may be learned by practice of the presented embodiments of the disclosure.

A first aspect of the present disclosure may provide a method of obtaining a position of a stationary target, the method including generating a fusion track based on data collected from a radar and data collected from a camera, determining whether the fusion track is in a stationary state, in response to the fusion track being in the stationary state, collecting radar points associated with the fusion track, and obtaining a center point of the stationary target based on the collected radar points.

A second aspect of the present disclosure may provide a device for obtaining a position of a stationary target, the device including a memory storing at least one program, and a processor configured to execute the at least one program to generate a fusion track based on data collected from a radar and data collected from a camera, determine whether the fusion track is in a stationary state, in response to the fusion track being in the stationary state, collect radar points associated with the fusion track, and obtain a center point of the stationary target based on the collected radar points.

A third aspect of the present disclosure may provide a method of generating a contour of a stationary target, the method including generating a fusion track based on data collected from a radar and data collected from a camera, determining whether the fusion track is in a stationary state, in response to the fusion track being in the stationary state, collecting radar points associated with the fusion track, and generating the contour of the stationary target based on the collected radar points.

A fourth aspect of the present disclosure may provide a device for generating a contour of a stationary target, the device including a memory storing at least one program, and a processor configured to execute the at least one program to generate a fusion track based on data collected from a radar and data collected from a camera, determine whether the fusion track is in a stationary state, in response to the fusion track being in the stationary state, collect radar points associated with the fusion track, and generate the contour of the stationary target based on the collected radar points.

A fifth aspect of the present disclosure may provide a computer-readable recording medium having recorded thereon a program for causing a computer to execute the method of the first aspect or the third aspect.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are diagrams for describing an autonomous driving method according to an embodiment;

FIG. 4 is a block diagram for schematically describing a sensor fusion system according to an embodiment;

FIG. 5 is a flowchart schematically illustrating a data conversion process in a fusion track generation process, according to an embodiment of the present disclosure;

FIG. 6 is a flowchart for describing a process of collecting radar points associated with a fusion track, according to an embodiment of the present disclosure;

FIGS. 7A and 7B are diagrams for describing a process of obtaining a center point of a target, according to an embodiment of the present disclosure;

FIGS. 8A to 8C are diagrams for describing a process of generating a contour of a stationary target, according to an embodiment of the present disclosure;

FIG. 9 is a flowchart of a method of obtaining a position of a stationary target, according to an embodiment;

FIG. 10 is a flowchart of a method of generating a contour of a stationary target, according to an embodiment; and

FIG. 11 is a block diagram of a device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

The terms used in the present application are merely used to describe example embodiments, and are not intended to limit the present disclosure. Singular forms are intended to include plural forms as well, unless the context clearly indicates otherwise. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

Some embodiments of the present disclosure may be represented by functional block components and various processing operations. Some or all of the functional blocks may be implemented by any number of hardware and/or software elements that perform particular functions. For example, the functional blocks of the disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the term ‘vehicle’ may refer to all types of transportation instruments with engines that are used to move passengers or goods, such as cars, buses, motorcycles, kick scooters, or trucks.

Hereinafter, the present disclosure will be described in detail with reference to the accompanying drawings.

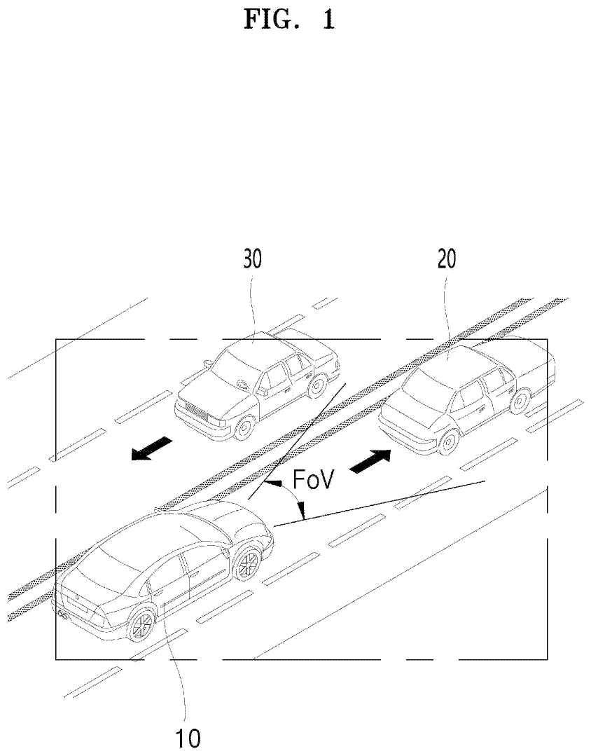

Referring to FIG. 1, an autonomous driving device according to an embodiment of the present disclosure may be mounted on a vehicle to implement an autonomous vehicle 10. The autonomous driving device mounted on the autonomous vehicle 10 may include various sensors (including cameras) configured to collect situational information around the autonomous vehicle 10. For example, the autonomous driving device may detect a movement of a preceding vehicle 20 traveling in front of the autonomous vehicle 10, through an image sensor and/or an event sensor mounted on the front side of the autonomous vehicle 10. The autonomous driving device may further include sensors configured to detect, in addition to the preceding vehicle 20 traveling in front of the autonomous vehicle 10, another traveling vehicle 30 traveling in an adjacent lane, and pedestrians around the autonomous vehicle 10.

At least one of the sensors configured to collect the situational information around the autonomous vehicle may have a certain field of view (FoV) as illustrated in FIG. 1. For example, in a case where a sensor mounted on the front side of the autonomous vehicle 10 has a FoV as illustrated in FIG. 1, information detected from the center of the sensor may have a relatively high importance. This may be because most of information corresponding to the movement of the preceding vehicle 20 is included in the information detected from the center of the sensor.

The autonomous driving device may control the movement of the autonomous vehicle 10 by processing information collected by the sensors of the autonomous vehicle 10 in real time, while storing, in a memory device, at least part of the information collected by the sensors.

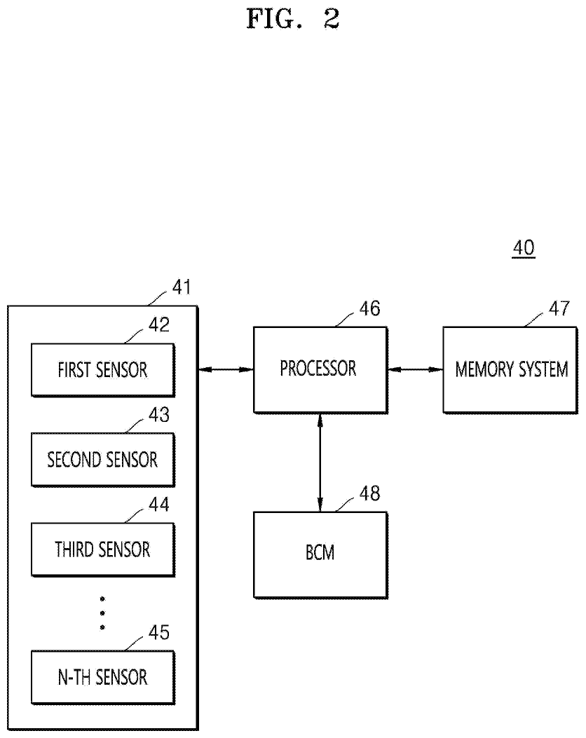

Referring to FIG. 2, an autonomous driving device 40 may include a sensor unit 41, a processor 46, a memory system 47, a body control module 48, and the like. The sensor unit 41 may include a plurality of sensors (including cameras) 42 to 45, and the plurality of sensors 42 to 45 may include an image sensor, an event sensor, an illuminance sensor, a global positioning system (GPS) device, an acceleration sensor, and the like.

Data collected by the sensors 42 to 45 may be delivered to the processor 46. The processor 46 may store, in the memory system 47, the data collected by the sensors 42 to 45, and control the body control module 48 based on the data collected by the sensors 42 to 45 to determine a movement of the vehicle. The memory system 47 may include two or more memory devices and a system controller configured to control the memory devices. Each of the memory devices may be provided as a single semiconductor chip.

In addition to the system controller of the memory system 47, each of the memory devices included in the memory system 47 may include a memory controller, which may include an artificial intelligence (AI) computation circuit such as a neural network. The memory controller may generate computational data by applying certain weights to data received from the sensors 42 to 45 or the processor 46, and store the computational data in a memory chip.

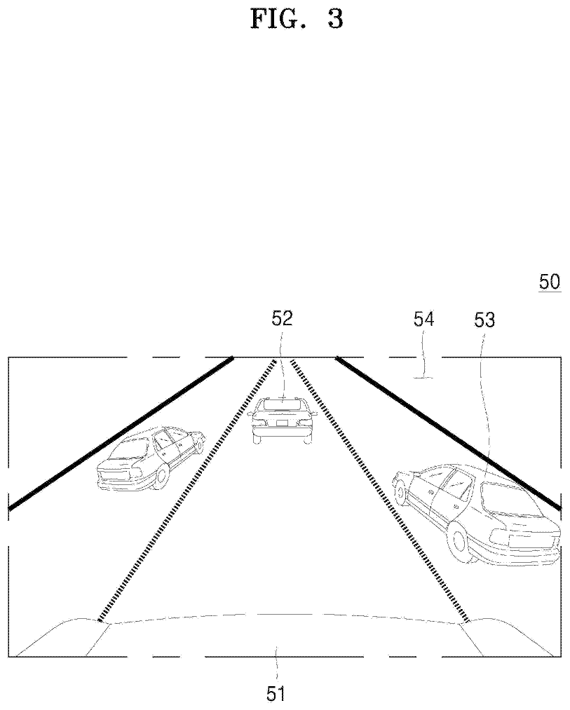

FIG. 3 is a diagram illustrating an example of image data obtained by sensors (including cameras) of an autonomous vehicle on which an autonomous driving device is mounted. Referring to FIG. 3, image data 50 may be data obtained by a sensor mounted on the front side of the autonomous vehicle. Thus, the image data 50 may include a front area 51 of the autonomous vehicle, a preceding vehicle 52 traveling in the same lane as the autonomous vehicle, a traveling vehicle 53 around the autonomous vehicle, a background 54, and the like.

In the image data 50 according to the embodiment illustrated in FIG. 3, data regarding a region including the front area 51 of the autonomous vehicle and the background 54 may be unlikely to affect the driving of the autonomous vehicle. In other words, the front area 51 of the autonomous vehicle and the background 54 may be regarded as data having a relatively low importance.

On the other hand, the distance to the preceding vehicle 52 and a movement of the traveling vehicle 53 to change lanes or the like may be significantly important factors in terms of safe driving of the autonomous vehicle. Accordingly, data regarding a region including the preceding vehicle 52 and the traveling vehicle 53 in the image data 50 may have a relatively high importance in terms of the driving of the autonomous vehicle.

A memory device of the autonomous driving device may apply different weights to different regions of the image data 50 received from a sensor, and then store the image data 50. For example, a high weight may be applied to the data regarding the region including the preceding vehicle 52 and the traveling vehicle 53, and a low weight may be applied to the data regarding the region including the front area 51 of the autonomous vehicle and the background 54.

Hereinafter, operations according to various embodiments may be understood as being performed by the autonomous driving device or the processor included in the autonomous driving device.

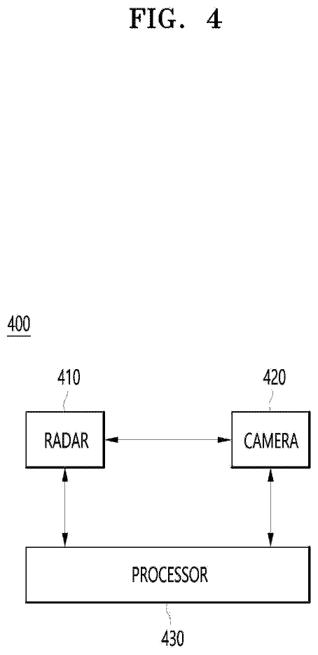

FIG. 4 is a block diagram for schematically describing a sensor fusion system according to an embodiment.

Hereinafter, a sensor fusion system 400 may be substantially the same as the autonomous driving device of the present disclosure, may be included in the autonomous driving device, or may be a component implemented as part of a function performed by the autonomous driving device.

In an embodiment, the sensor fusion system 400 may include a radar 410, a camera 420, and a processor 430.

The radar 410 may obtain radar points by radiating radio waves to a surrounding area and detecting waves incident thereon after being reflected from an object, and determine distance information to the object, in particular, longitudinal distance information, based on the obtained radar points. Here, the radar 410 may determine state information of the vehicle through an antenna, transmitting/receiving ends, and a signal processing end. For example, the radar 410 may detect the distance, angle, and speed of each object by using a transmitting antenna and a plurality of receiving antennas.

The radar 410 may be relatively robust to the external environment and may detect an accurate distance based on a round-trip time of radio waves. In addition, the radar 410 may indirectly obtain speed information of a nearby vehicle by using Doppler frequencies reflected from objects.

However, the radar 410 has relatively low angle detection performance and thus may recognize all objects with a small number of points, and has lower accuracy of position recognition of stationary objects (e.g., vehicles) than accuracy of position recognition of moving objects. Thus, an additional process may be required to recognize or distinguish surrounding objects based on information obtained through the radar 410.

The camera 420 may be mounted on at least one of a front surface, a rear surface, and a side surface of the vehicle, and may obtain image data and deliver the image data to the processor. Features of an object may be extracted from the obtained image data, a bounding box may be set for the object, and tracking information for the object may be obtained.

The processor 430 may calibrate the radar 410 and the camera 420, generate a sensor fusion image by matching distance information to objects obtained by the radar 410 with image data obtained by the camera 420, and determine positions of surrounding objects included in the image data by analyzing radar points and the sensor fusion image.

Meanwhile, the sensor fusion system accumulates a plurality of radar points and uses them as data for determining a position of an object, and in general, uses the plurality of radar points obtained by accumulating radar points for a particular time period, on an hourly basis.

The sensor fusion system may generate a radar point cloud by clustering a plurality of accumulated radar points. For example, an algorithm such as density-based spatial clustering of applications with noise (DBSCAN) or a k-means algorithm may be used for the clustering. However, a clustering algorithm used to generate a radar point cloud may require a large amount of computation.

Thus, the present disclosure proposes a method and device capable of improving accuracy of a radar in recognizing a stationary target, and reducing the amount of computation required to determine a position of the target.

A device for obtaining a position of a stationary target or a device for generating a contour of a stationary target according to various embodiments of the present disclosure may be substantially the same as the sensor fusion system, may be included in the sensor fusion system, or may be a component implemented as part of a function performed by the sensor fusion system.

The device for obtaining a position of a stationary target and the device for generating a contour of a stationary target according to various embodiments of the present disclosure may be substantially the same device.

The device for obtaining a position of a stationary target of the present disclosure may generate a fusion track based on data collected from a radar and a camera. The device for obtaining a position of a stationary target of the present disclosure may determine whether the generated fusion track is in a stationary state. When the fusion track is in the stationary state, the device for obtaining a position of a stationary target may collect radar points associated with the fusion track. The device for obtaining a position of a stationary target may obtain a center point of the target based on the radar points collected for the fusion track in the stationary state.

The device for generating a contour of a stationary target of the present disclosure may generate a fusion track based on data collected from a radar and a camera. The device for generating a contour of a stationary target of the present disclosure may determine whether the generated fusion track is in a stationary state. When the fusion track is in the stationary state, the device for generating a contour of a stationary target may collect radar points associated with the fusion track. The device for generating a contour of a stationary target of the present disclosure may generate a contour of the target based on the collected radar points.

Hereinafter, a method, performed by the device for obtaining a position of a stationary target, of obtaining a position of a stationary target, and a method, performed by the device for generating a contour of a stationary target, of generating a contour of a stationary target will be described in detail.

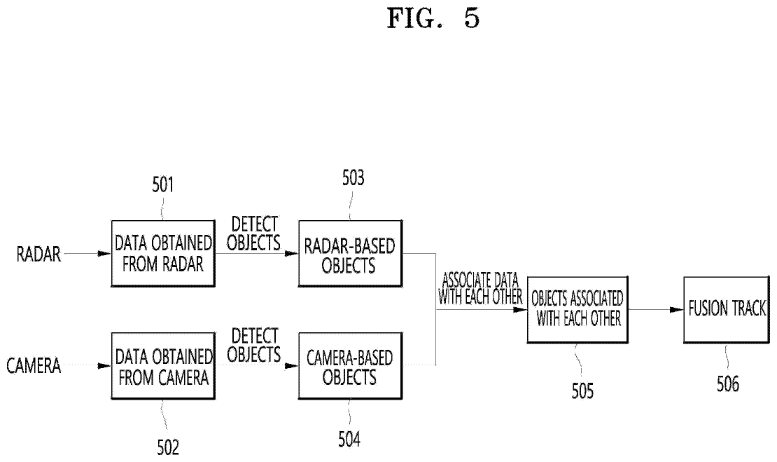

A process in which the device for obtaining a position of a stationary target or the device for generating a contour of a stationary target generates a fusion track will be described with reference to FIG. 5.

FIG. 5 is a flowchart schematically illustrating data conversion in a fusion track generation process, according to an embodiment of the present disclosure.

In the present disclosure, the device for obtaining a position of a stationary target or a device for generating a contour of a stationary target may include a radar and a camera, and may collect data from the radar and the camera. In an embodiment, the device for obtaining a position of a stationary target or the device for generating a contour of a stationary target may preprocess the data collected from the radar and the camera.

In the present disclosure, the device for obtaining a position of a stationary target or the device for generating a contour of a stationary target may generate a fusion track based on the data collected from the radar and data collected from the camera.

In detecting an object around a vehicle, longitudinal position information may be relatively accurately reflected in data collected from the radar, and transverse position information may be relatively accurately reflected in data collected from the camera. The device for obtaining a position of a stationary target or the device for generating a contour of a stationary target of the present disclosure may associate the data collected from the radar with the data collected from the camera in order to complement the above-described characteristics of sensors (e.g., the radar and camera).

In detail, in an embodiment, the device for obtaining a position of a stationary target or the device for generating a contour of a stationary target may detect radar-based objects based on the data collected from the radar, and detect camera-based objects based on the data collected from the camera.

Referring to FIG. 5, the device for obtaining a position of a stationary target or the device for generating a contour of a stationary target may detect objects based on data 501 obtained from the radar to generate radar-based objects 503, and detect objects based on data 502 obtained from the camera to generate camera-based objects 504.

In an embodiment, the device for obtaining a position of a stationary target or the device for generating a contour of a stationary target may determine objects associated with each other from among the radar-based objects and the camera-based objects, and generate a fusion track for the objects associated with each other. It would be easily understood by those of skill in the art that the radar-based objects may include one or more objects, the camera-based objects may include one or more objects, and the objects associated with each other may also include one or more objects.

Referring to FIG. 5, the device for obtaining a position of a stationary target or the device for generating a contour of a stationary target may determine objects 505 associated with each other from among the radar-based objects 503 and the camera-based objects 504.

In an embodiment, the device for obtaining a position of a stationary target or the device for generating a contour of a stationary target may associate pieces of data with each other based on distance. For example, the device for obtaining a position of a stationary target or the device for generating a contour of a stationary target may determine whether a radar-based object and a camera-based object are associated with each other, based on distance information according to the data collected from the radar and distance information based on the data collected from the camera.

Referring to FIG. 5, the device for obtaining a position of a stationary target or the device for generating a contour of a stationary target may generate a fusion track 506 for the objects 505 associated with each other.

In the present disclosure, the device for obtaining a position of a stationary target or the device for generating a contour of a stationary target may collect radar points for the generated fusion track and generate a point cloud based on the collected radar points.

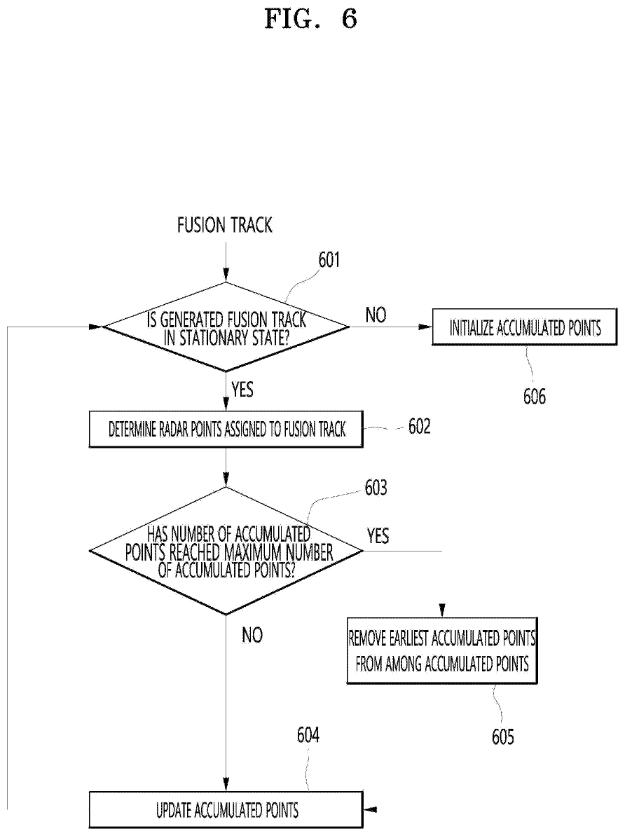

A process in which the device for obtaining a position of a stationary target or the device for generating a contour of a stationary target collects radar points will be described with reference to FIG. 6.

FIG. 6 is a flowchart for describing a process of collecting radar points associated with a fusion track, according to an embodiment of the present disclosure.

In an embodiment, the device for obtaining a position of a stationary target or the device for generating a contour of a stationary target may determine whether a generated fusion track is in a stationary state (601).

In general, the accuracy in estimation of position information of a stationary object based on data collected from a radar is low. Accordingly, the device for obtaining a position of a stationary target or the device for generating a contour of a stationary target of the present disclosure may determine whether the fusion track is in the stationary state, and based on the fusion track being in the stationary state, estimate an accurate position of a target or a contour of the target, through an additional process.

In the present disclosure, the device for obtaining a position of a stationary target or the device for generating a contour of a stationary target may determine whether the fusion track is in the stationary state based on any suitable manner.

In an embodiment, the device for obtaining a position of a stationary target or the device for generating a contour of a stationary target may determine whether the fusion track is in the stationary state, based on a speed of an object according to data collected from the radar, and an absolute speed of the fusion track.

In an embodiment, the device for obtaining a position of a stationary target or the device for generating a contour of a stationary target may, in response to the fusion track being in the stationary state, determine radar points assigned to the fusion track (hereinafter, referred to as a ‘first track’) determined to be in the stationary state (602).

The radar point is obtained when a radio wave emitted from the radar is reflected by an object and then enters the radar to be detected, and may include distance information between an ego vehicle and the object.

In the present disclosure, the data collected from the radar includes radar points, and the radar points may be for data about all objects around the ego vehicle. In an embodiment, the device for obtaining a position of a stationary target or the device for generating a contour of a stationary target may determine radar points assigned to the first track from among data collected from the radar.

Meanwhile, the device for obtaining a position of a stationary target or the device for generating a contour of a stationary target may collect radar points associated with the fusion track by updating accumulated points on an hourly basis. However, when radar points are collected on an hourly basis, and both the ego vehicle and the target (i.e., the fusion track) are stationary, the collected radar points may be sparse.

In the present disclosure, the device for obtaining a position of a stationary target or the device for generating a contour of a stationary target may collect radar points associated with the fusion track based on the number of accumulated points. Collecting radar points based on the number of accumulated points rather than on an hourly basis may be advantageous for collecting data regarding a stationary object.

In an embodiment, the maximum number of accumulated points for one fusion track, that is, the number of radar points that may be included in accumulated points for one fusion track, may be predetermined. For example, the device for obtaining a position of a stationary target or the device for generating a contour of a stationary target may collect up to 300, 500, or 700 radar points for one fusion track.

In an embodiment, the device for obtaining a position of a stationary target or the device for generating a contour of a stationary target may determine whether the number of accumulated points has reached the maximum number of accumulated points (603).

In an embodiment, when the number of accumulated points has not reached the maximum number of accumulated points, the device of obtaining a position of a stationary target or the device for generating a contour of a stationary target may update the accumulated points associated with the fusion track based on the radar points assigned to the fusion track (604). In detail, the device for obtaining a position of a stationary target or the device for generating a contour of a stationary target may determine radar points assigned to the first track from among the data collected from the radar, and update the accumulated points for the first track by adding the determined radar points to the accumulated points for the first track.

In an embodiment, when the number of accumulated points has reached the maximum number of accumulated points, the device for obtaining a position of a stationary target or the device for generating a contour of a stationary target may remove first accumulated points from among the accumulated points (605). For example, when the number of radar points assigned to the fusion track is N, N first accumulated points may be removed from among the accumulated points. Next, the device for obtaining a position of a stationary target or the device for generating a contour of a stationary target may update the accumulated points based on newly determined radar points assigned to the fusion track (604).

In an embodiment, the device for obtaining a position of a stationary target or the device for generating a contour of a stationary target may continuously repeat the process of collecting points.

In an embodiment, the device for obtaining a position of a stationary target or the device for generating a contour of a stationary target may compensate for a distance traveled by the ego vehicle in the process of accumulating radar points associated with the fusion track. In detail, the updating of the accumulation points for the first track by the device for obtaining a position of a stationary target or the device for generating a contour of a stationary target may include compensating previous accumulated points for a distance traveled by the ego vehicle from a previous update time point.

For example, the device for obtaining a position of a stationary target or the device for generating a contour of a stationary target may determine coordinates of a new radar point associated with the fusion track by adding compensation values to coordinates of a previous radar point associated with the fusion track, based on the speed, time, and rotation degree of the ego vehicle.

In an embodiment, the device for obtaining a position of a stationary target or the device for generating a contour of a stationary target may initialize the accumulated points in response to determination that the fusion track that was in the stationary state is not in the stationary state (606). In other words, the device for obtaining a position of a stationary target or the device for generating a contour of a stationary target may continuously verify whether the first track remains in the stationary state, while collecting radar points for the first track, and when the first track is out of the stationary state, initialize the accumulated points for the first track.

In the present disclosure, the device for obtaining a position of a stationary target may generate a point cloud based on the accumulated points. In an embodiment, the device for obtaining a position of a stationary target may obtain a center point of the target based on the point cloud.

In the present disclosure, the device for generating a contour of a stationary target may generate contours of the target based on the accumulated points.

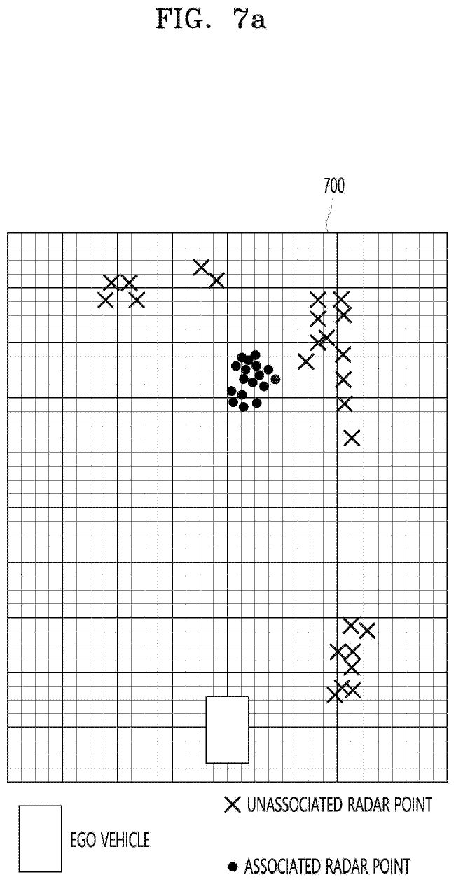

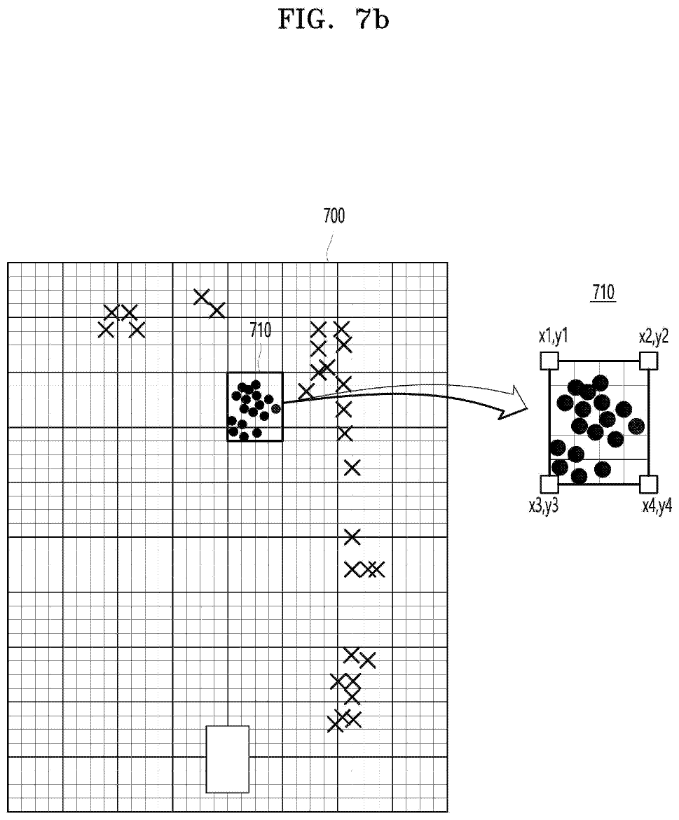

A process in which the device for obtaining a position of a stationary target obtains a center point of a target will be described with reference to FIGS. 7A and 7B.

FIGS. 7A and 7B are diagrams for describing a process of obtaining a center point of a target, according to an embodiment of the present disclosure.

In the present disclosure, the device for obtaining a position of a stationary target may generate a grid map based on data collected from the radar and data collected from the camera.

Referring to FIG. 7A, a grid map 700 may include cells forming a rectangular tile, and the device for obtaining a position of a stationary target may use the cells of the grid map 700 as coordinates. The interval between the cells expressed in the grid map 700, the scale of the actual distance to an object, and the like may be arbitrarily determined according to the specifications or requirements of a sensor mounted on a vehicle or the device for obtaining a position of a stationary target.

Referring to FIG. 7A, the grid map 700 may include a mark indicating the ego vehicle and one or more radar points. The device for obtaining a position of a stationary target may display detected radar points by using the cells included in the grid map 700 as coordinates with respect to the ego vehicle. That is, the radar points represent distance information to objects, and thus, relative positions between a plurality of detected radar points may be expressed on the grid map 700.

The radar points expressed in the grid map 700 may include associated radar points and unassociated radar points. FIG. 7A illustrates one or more associated radar points and one or more unassociated radar points.

In FIG. 7A, the associated radar points are radar points assigned to a particular fusion track and may be radar points updated to accumulated points. That is, in the present disclosure, the device for obtaining a position of a stationary target may map radar points associated with a fusion track as associated radar points on the generated grid map 700.

On the other hand, in FIG. 7A, the one or more unassociated radar points may be radar points that are not associated with the fusion track, that is, radar points that are not assigned to the fusion track.

In the present disclosure, the device for obtaining a position of a stationary target may obtain a center point of a target based on the associated radar points mapped to the grid map 700.

Referring to FIG. 7B, the device for obtaining a position of a stationary target may generate a target tile 710, which is the smallest rectangle including all radar points assigned to a particular fusion track, in units of tiles. In other words, the target tile 710 may have a rectangular shape and may include one or more tiles including associated radar points mapped to the grid map 700.

In an embodiment, the device for obtaining a position of a stationary target may determine the center point of the target based on corner points of the target tile 710. The corner points may refer to four corners constituting the target tile 710.

In detail, the device for obtaining a position of a stationary target may determine the center point of the target based on coordinates of each corner point. Referring to FIG. 7B, the target tile 710 includes a first corner point, a second corner point, a third corner point, and a fourth corner point, and the coordinates of the first corner point are (x1, y1), the coordinates of the second corner point are (x2, y2), the coordinates of the third corner point are (x3, y3), and the coordinates of the fourth corner point are (x4, y4).

In detail, the device for obtaining a position of a stationary target may obtain four candidate center points from the coordinates of the respective four corner points. For example, the device for obtaining a position of a stationary target may obtain x-coordinate and y-coordinate of a candidate center point based on the x-coordinate and y-coordinate of a corner point, the length of the fusion track, the width of the fusion track, and the rotation angle of the fusion track.

In an embodiment, the device for obtaining a position of a stationary target may obtain the center point of the target from the four candidate center points. In an embodiment, the device for obtaining a position of a stationary target may determine, as the center point of the target, the candidate center point with the least change among the four candidate center points, based on data regarding a previous frame.

In an embodiment, the device for obtaining a position of a stationary target may estimate a posture of the target based on the four candidate center points.

In the present disclosure, the device for obtaining a position of a stationary target may determine the center point of the determined target as the position of the stationary target.

In an embodiment, the size or volume occupied by the target may be determined based on the type (e.g., vehicle model) of the target identified through image data, and the determined center point of the target.

In the present disclosure, the device for obtaining a position of a stationary target may control driving of the ego vehicle based on the obtained position of the stationary target.

In an embodiment, the device for obtaining a position of a stationary target may determine a driving path to avoid one or more stationary targets, based on positions of the stationary targets.

In an embodiment, when a stationary target is present on an existing driving path of the ego vehicle, the device for obtaining a position of a stationary target may determine to change the driving path, based on the position of the target.

In an embodiment, the device for obtaining a position of a stationary target may determine a driving method of the ego vehicle by determining in which lane the stationary target is stopped, based on the position of the stationary target. For example, when the target is stopped in a lane adjacent to a sidewalk, the device for obtaining a position of a stationary target may determine to drive to overtake the target.

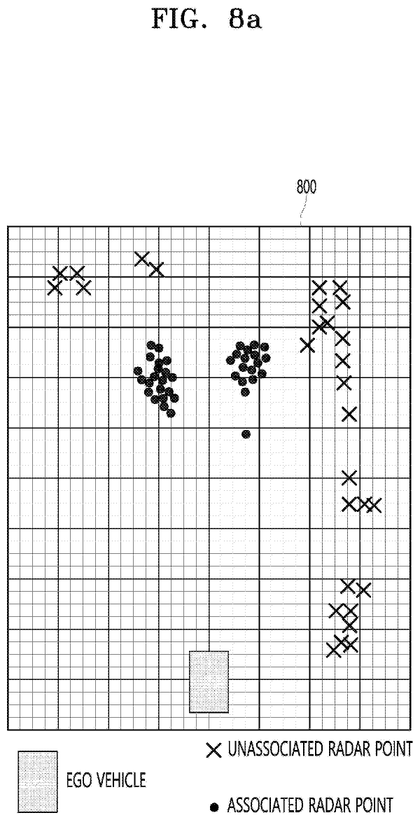

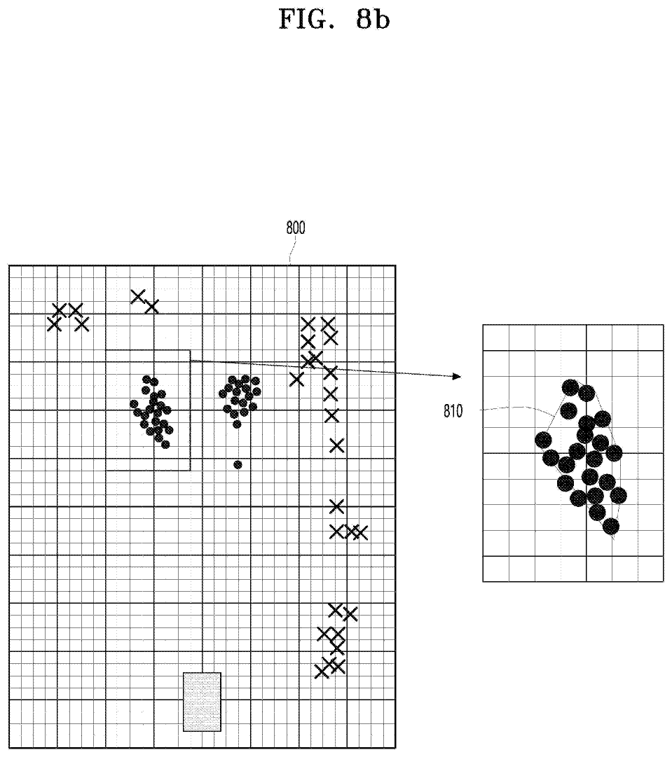

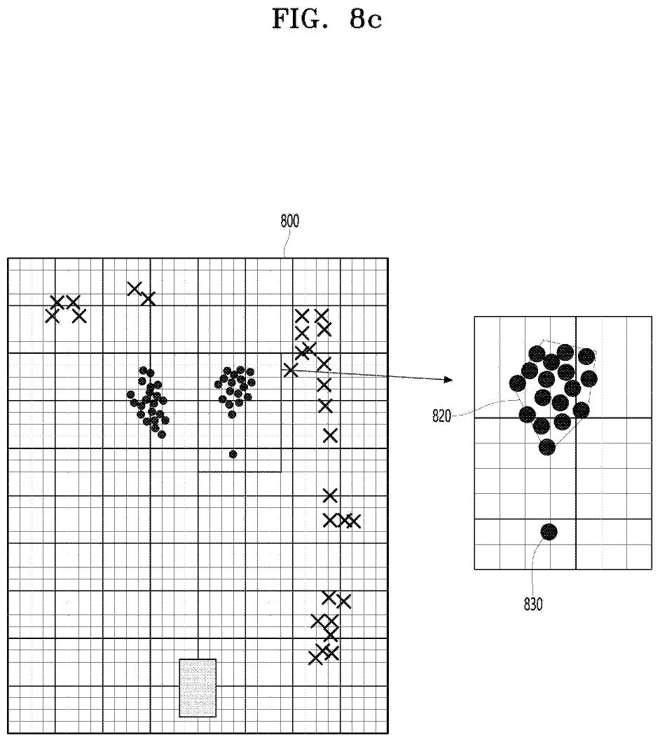

A process of generating a contour of a target based on accumulated points will be described with reference to FIGS. 8A to 8C.

FIGS. 8A to 8C are diagrams for describing a process of generating a contour of a stationary target, according to an embodiment of the present disclosure.

In the present disclosure, the device for generating a contour of a stationary target may generate a grid map based on data collected from the radar and data collected from the camera.

Referring to FIG. 8A, a grid map 800 may include cells forming a rectangular tile, and the device for generating a contour of a stationary target may use cells of the grid map 800 as coordinates. The interval between the cells expressed in the grid map 800, the scale of the actual distance to an object, and the like may be arbitrarily determined according to the specifications or requirements of a sensor mounted on a vehicle or the device for generating a contour of a stationary target.

Referring to FIG. 8A, the grid map 800 may include a mark indicating the ego vehicle and one or more radar points. The device for generating a contour of a stationary target may display detected radar points by using the cells included in the grid map 800 as coordinates with respect to the ego vehicle. That is, the radar points represent distance information to objects, and thus, relative positions between a plurality of detected radar points may be expressed on the grid map 800.

The radar points expressed in the grid map 800 may include associated radar points and unassociated radar points. FIG. 8A illustrates one or more associated radar points and one or more unassociated radar points.

In FIG. 8A, the associated radar points are radar points assigned to a particular fusion track and may be radar points updated to accumulated points. That is, in the present disclosure, the device for generating a contour of a stationary target may map radar points associated with a fusion track as associated radar points on the generated grid map 800.

On the other hand, in FIG. 8A, the one or more unassociated radar points may be radar points that are not associated with the fusion track, that is, radar points that are not assigned to the fusion track.

Meanwhile, as illustrated in FIG. 8A, a plurality of associated radar points are densely clustered to form two groups, and each group may correspond to an individual target. That is, in the illustrated example, the grid map 800 includes information about two objects detected as the radar points, wherein the group of associated radar points clustered on the left may correspond to a first fusion track, and the group of associated radar points clustered on the right may correspond to a second fusion track.

In the present disclosure, the device for generating a contour of a stationary target may detect a contour based on associated radar points mapped to a grid map 800.

FIG. 8B illustrates a first contour 810 detected based on the associated radar points for the first fusion track among the associated radar points mapped to the grid map 800.

Referring to FIG. 8B, the device for generating a contour of a stationary target may apply an algorithm for detecting a contour, to the associated radar points that are accumulated and mapped. In other words, the device for generating a contour of a stationary target may detect the first contour 810 by applying the algorithm for detecting a contour to the radar points for the first fusion track. For example, the algorithm may be a convex hull algorithm.

In addition, in an embodiment, the device for generating a contour of a stationary target may remove radar points corresponding to noise from among the mapped associated radar points. Unlike the unassociated radar points, the radar points corresponding to the noise may refer to radar points that correspond to a particular fusion track and thus are associated radar points, but do not actually reflect information of the fusion track due to a measurement error, a temporary obstacle, or the like. Therefore, the device for generating a contour of a stationary target of the present disclosure may accurately generate a contour by removing radar points corresponding to noise.

FIG. 8C illustrates a second contour 820 detected based on the associated radar points for the second fusion track among the associated radar points mapped to the grid map 800.

Referring to FIG. 8C, the device for generating a contour of a stationary target may detect the second contour 820 from the radar points for the second fusion track, and may exclude a radar point 830 corresponding to noise. That is, in the illustrated example, the device for generating a contour of a stationary target may determine that the radar point 830 corresponding to the noise does not reflect information of the second fusion track, and detect the second contour 820 after removing the radar point 830 corresponding to the noise.

In an embodiment, the device for generating a contour of a stationary target may use a grid map to determine radar points corresponding to noise. For example, when there are no radar points around a particular radar point, the device for generating a contour of a stationary target may determine that the particular radar point corresponds to noise. Whether a radar point exists around a particular radar point may be determined based on the grid map. For example, criteria for the determination may include whether a radar point exists above, below, or on the left or right of the particular radar point within a threshold distance based on the grid map. For example, the threshold distance may be twice the length of one side of the cell.

In the present disclosure, the device for generating a contour of a stationary target may generate a contour of a stationary target based on a detected contour.

In the present disclosure, the device for generating a contour of a stationary target may control driving of the ego vehicle or generate information for driving the ego vehicle, based on the generated contour.

For example, the device for generating a contour of a stationary target may determine a driving path to avoid one or more stationary targets, based on contours of the stationary targets. For example, when a stationary target is present on an existing driving path of the ego vehicle, the device for generating a contour of a stationary target may determine to change the driving path, based on the contour of the target. For example, the device for generating a contour of a stationary target may determine a driving method (e.g., drive to overtake) of the ego vehicle by determining in which lane the stationary target is stopped, based on the contour of the stationary target.

In an embodiment, the device for generating a contour of a stationary target may determine the nearest point based on the generated contour. The nearest point may refer to a point closest to the ego vehicle in the generated contours. The nearest point may include information about the shortest distance between to the ego vehicle and the surface of the object. In an embodiment, the device for generating a contour of a stationary target may control driving of the ego vehicle or generate information for driving the ego vehicle, based on the nearest point.

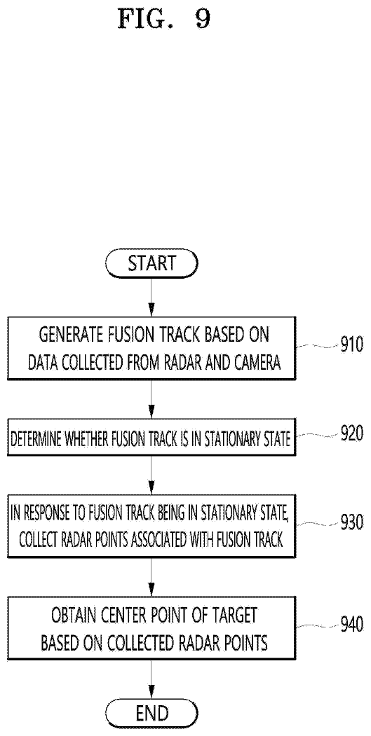

FIG. 9 is a flowchart of a method of obtaining a position of a stationary target, according to an embodiment.

Operations illustrated in FIG. 9 may be performed by the device for obtaining a position of a stationary target described above. In detail, the operations illustrated in FIG. 9 may be performed by a processor included in the device for obtaining a position of a stationary target described above.

In operation 910, the device for obtaining a position of a stationary target may generate a fusion track based on data collected from the radar and the camera.

In an embodiment, operation 910 may include detecting one or more radar-based objects based on the data collected from the radar.

In an embodiment, operation 910 may include detecting one or more camera-based objects based on the data collected from the camera.

In an embodiment, operation 910 may include generating a fusion track by determining objects associated with each other from among the one or more radar-based objects and the one or more camera-based objects.

In an embodiment, the determining of the objects associated with each other may be performed based on distances from the ego vehicle to the radar-based objects and distances from the ego vehicle to the camera-based objects.

In operation 920, the device for obtaining a position of a stationary target may determine whether the fusion track is in a stationary state.

In operation 930, the device for obtaining a position of a stationary target may, in response to the fusion track being in the stationary state, collect radar points associated with the fusion track.

In an embodiment, operation 930 may include determining radar points assigned to the fusion track from among the collected data.

In an embodiment, operation 930 may include updating accumulated points associated with the fusion track, based on the radar points assigned to the fusion track.

In an embodiment, a maximum number of radar points included in the accumulated points associated with the fusion track may be predetermined.

In an embodiment, the updating of the accumulated points associated with the fusion track may include compensating the previous accumulated points for a distance traveled by the ego vehicle from a previous update time point.

In operation 940, a center point of the target may be obtained based on the collected radar points.

In an embodiment, operation 940 may include generating a grid map based on the data collected from the radar and the camera.

In an embodiment, operation 940 may include mapping the radar points associated with the fusion track to the grid map.

In an embodiment, operation 940 may include determining a target tile including one or more tiles including the mapped radar points.

In an embodiment, operation 940 may include obtaining corner points of the target tile.

In an embodiment, operation 940 may further include determining the center point of the target based on the corner points.

In an embodiment, the method of obtaining a position of a stationary target may further include, in response to the fusion track not being in the stationary state, initializing the accumulated points.

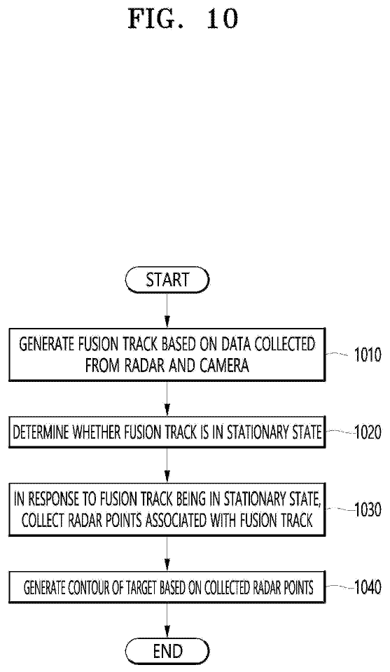

FIG. 10 is a flowchart of a method of generating a contour of a stationary target, according to an embodiment.

Operations illustrated in FIG. 10 may be performed by the device for generating a contour of a stationary target described above. In detail, the operations illustrated in FIG. 10 may be performed by a processor included in the device for generating a contour of a stationary target described above.

In operation 1010, the device for generating a contour of a stationary target may generate a fusion track based on data collected from the radar and the camera.

In an embodiment, operation 1010 may include detecting one or more radar-based objects based on the data collected from the radar.

In an embodiment, operation 1010 may include detecting one or more camera-based objects based on the data collected from the camera.

In an embodiment, operation 1010 may include generating a fusion track by determining objects associated with each other from among the one or more radar-based objects and the one or more camera-based objects.

In an embodiment, the determining of the objects associated with each other may be performed based on distances from the ego vehicle to the radar-based objects and distances from the ego vehicle to the camera-based objects.

In operation 1020, the device for generating a contour of a stationary target may determine whether the fusion track is in a stationary state.

In operation 1030, the device for generating a contour of a stationary target may, in response to the fusion track being in the stationary state, collect radar points associated with the fusion track.

In an embodiment, operation 1030 may include determining radar points assigned to the fusion track from among the collected data.

In an embodiment, operation 1030 may include updating accumulated points associated with the fusion track, based on the radar points assigned to the fusion track.

In an embodiment, a maximum number of radar points included in the accumulated points associated with the fusion track may be predetermined.

In an embodiment, the updating of the accumulated points associated with the fusion track may include compensating the previous accumulated points for a distance traveled by the ego vehicle from a previous update time point.

In operation 1040, a contour of the target may be generated based on the collected radar points.

In an embodiment, operation 1040 may include generating a grid map based on the data collected from the radar and the camera.

In an embodiment, operation 1040 may include mapping the radar points associated with the fusion track to the grid map.

In an embodiment, operation 1040 may include detecting a contour based on the mapped radar points.

In an embodiment, operation 1040 may further include removing a radar point corresponding to noise from among the mapped radar points.

In an embodiment, the detecting of the contour may include applying a convex hull algorithm to the mapped radar points.

In an embodiment, the method of generating a contour of a stationary target may further include, in response to the fusion track not being in the stationary state, initializing the accumulated points.

In an embodiment, the method of generating a contour of a stationary target may further include determining a nearest point based on the generated contour of the target.

In an embodiment, the method of generating a contour of a stationary target may further include controlling driving of the ego vehicle based on the nearest point.

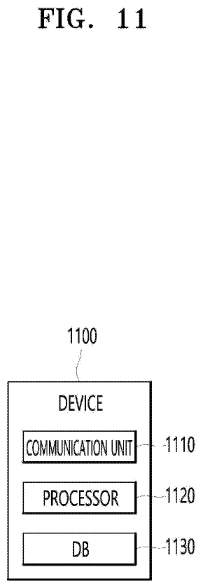

FIG. 11 is a block diagram of a device according to an embodiment.

The device of FIG. 11 according to an embodiment may be the device for obtaining a position of a stationary target or the device for generating a contour of a stationary target described above.

Referring to FIG. 11, a device 1100 may include a communication unit 1110, a processor 1120, and a database (DB) 1130. FIG. 11 illustrates the device 1100 including only the components related to an embodiment. Therefore, it would be understood by those of skill in the art that other general-purpose components may be further included in addition to those illustrated in FIG. 11.

The communication unit 1110 may include one or more components for performing wired/wireless communication with an external server or an external device. For example, the communication unit 1110 may include at least one of a short-range communication unit (not shown), a mobile communication unit (not shown), and a broadcast receiver (not shown).

The DB 1130 is hardware for storing various pieces of data processed by the device 1100, and may store a program for the processor 1120 to perform processing and control. The DB 1130 may store payment information, user information, and the like.

The DB 1130 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1120 controls the overall operation of the device 1100. For example, the processor 1120 may execute programs stored in the DB 1130 to control the overall operation of an input unit (not shown), a display (not shown), the communication unit 1110, the DB 1130, and the like. The processor 1120 may execute programs stored in the DB 1130 to control the operation of the device 1100.

The processor 1120 may control at least some of the operations of the device 1100 described above with reference to FIGS. 1 to 10.

The processor 1120 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the device 1100 may be a mobile electronic device. For example, the device 1100 may be implemented as a smart phone, a tablet personal computer (PC), a PC, a smart television (TV), a personal digital assistant (PDA), a laptop computer, a media player, a navigation system, a camera-equipped device, and other mobile electronic devices. In addition, the device 1100 may be implemented as a wearable device having a communication function and a data processing function, such as a watch, glasses, a hair band, a ring, or the like.

In another embodiment, the device 1100 may be an electronic device embedded in a vehicle. For example, the device 1100 may be an electronic device that is manufactured and then inserted into a vehicle through tuning.

As another embodiment, the device 1100 may be a server located outside a vehicle. The server may be implemented as a computer device or a plurality of computer devices that provide a command, code, a file, content, a service, and the like by performing communication through a network. The server may receive data necessary for determining a movement path of a vehicle from devices mounted on the vehicle, and determine the movement path of the vehicle based on the received data.

In another embodiment, a process performed by the device 1100 may be performed by at least some of a mobile electronic device, an electronic device embedded in the vehicle, and a server located outside the vehicle.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods according to the present disclosure may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as failing within the scope of the present disclosure.

According to an embodiment of the present disclosure, position tracking with high precision is possible by processing information collected by a radar and a camera, and thus, expensive and high-precision equipment for recognizing nearby vehicles may be replaced.

In addition, according to an embodiment of the present disclosure, it is possible to obtain a position of even a stationary target with high accuracy, and real-time position tracking is guaranteed because a complicated algorithm is not used.

In addition, an accurate posture of a target may be estimated by filtering out surrounding noise through a grid map.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of obtaining a position of a stationary target, the method comprising:
generating a fusion track based on data collected from a radar and data collected from a camera;
determining whether the fusion track is in a stationary state;
in response to the fusion track being in the stationary state, collecting radar points associated with the fusion track; and
obtaining a center point of the stationary target based on the collected radar points.

2. The method of claim 1, wherein the generating of the fusion track comprises:
detecting one or more radar-based objects based on the data collected from the radar;
detecting one or more camera-based objects based on the data collected from the camera; and
generating the fusion track by determining objects associated with each other from among the one or more radar-based objects and the one or more camera-based objects.

3. The method of claim 2, wherein the determining of the objects associated with to each other is based on distances from an ego vehicle to the one or more radar-based objects and distances from the ego vehicle to the one or more camera-based objects.

4. The method of claim 1, wherein the collecting of the radar points associated with the fusion track comprises:
determining radar points assigned to the fusion track from among the collected data; and
updating accumulated points associated with the fusion track based on the radar points assigned to the fusion track.

5. The method of claim 4, wherein a maximum number of radar points included in the accumulated points associated with the fusion track is predetermined.

6. The method of claim 4, wherein the updating of the accumulated points associated with the fusion track comprises compensating previous accumulated points for a distance traveled by an ego vehicle from a previous update time point.

7. The method of claim 4, further comprising, in response to the fusion track not being in the stationary state, initializing the accumulated points.

8. The method of claim 1, wherein the obtaining of the center point of the stationary target comprises:
generating a grid map based on the data collected from the radar and the data collected from the camera; and
mapping the radar points associated with the fusion track to the grid map.

9. The method of claim 8, wherein the obtaining of the center point of the stationary target further comprises:
determining a target tile comprising one or more tiles comprising the mapped radar points;
obtaining corner points of the target tile; and
determining the center point of the stationary target based on the corner points.

10. The method of claim 1, further comprising controlling driving of an ego vehicle based on the center point of the stationary target.

11. The method of claim 1, further comprising generating a contour of the stationary target based on the collected radar points.

12. The method of claim 11, wherein the generating of the contour of the stationary target comprises:
generating a grid map based on the data collected from the radar and the data collected from the camera;
mapping the radar points associated with the fusion track to the grid map; and
detecting the contour based on the mapped radar points.

13. The method of claim 12, wherein the generating of the contour of the stationary target further comprises removing radar points corresponding to noise from among the mapped radar points.

14. The method of claim 12, wherein the detecting of the contour comprises applying a convex hull algorithm to the mapped radar points.

15. The method of claim 11, further comprising: determining a nearest point based on the generated contour of the stationary target; and
controlling driving of an ego vehicle based on the nearest point.

16. A device for obtaining a position of a stationary target, the device comprising:
a memory storing at least one program; and
a processor configured to
execute the at least one program to generate a fusion track based on data collected from a radar and data collected from a camera,
determine whether the fusion track is in a stationary state, in response to the fusion track being in the stationary state,
collect radar points associated with the fusion track, and
obtain a center point of the stationary target based on the collected radar points.

17. A computer-readable recording medium having recorded thereon a program for causing a computer to execute the method of claim 1.
